(19) United States
(12) Patent Application Publication
(10) Pub. No.: US 2003/0163997 A1
(43) Pub. Date: Sep. 4, 2003

(54) Cryogenic refrigeration unit suited for delivery vehicles

(76) Inventors: Herman H. Viegas, Bloomington, MN (US); Jayaram Seshadri, Minneapolis, MN (US); Hans-Olof Nilsson, Agnesberg (SE)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/905,700

(22) Filed: Oct. 2, 2001

Related U.S. Application Data
(60) Provisional application No. 60/238,929, filed on Oct. 10, 2000.

(51) Int. Cl. F17C 9/02; F25D 15/00; B60H 1/32

(52) U.S. Cl. 62/50.2; 62/239; 62/119

(57) ABSTRACT

A temperature control system for a motor vehicle includes a housing having an air inlet and an air outlet, both of which are in fluid communication with an air-conditioned space of the vehicle. An evaporator coil is mounted within the housing and provides a pathway for a heat-absorbing fluid between a heat-absorbing fluid tank and the atmosphere. A blower mounted within the housing between the air inlet and the evaporator coil is driven by the motor vehicle engine, and blows air to be conditioned over the evaporator coil. A heating coil is positioned adjacent to the evaporator coil, and provides a heating flow path for engine coolant such that hot engine coolant flows from the engine, through the evaporator coil, and back to the engine. The heating coil is used to thaw out moisture that has frozen onto the outer surface of the evaporator coil.

### DESCRIPTION OF PREFERRED EMBODIMENT

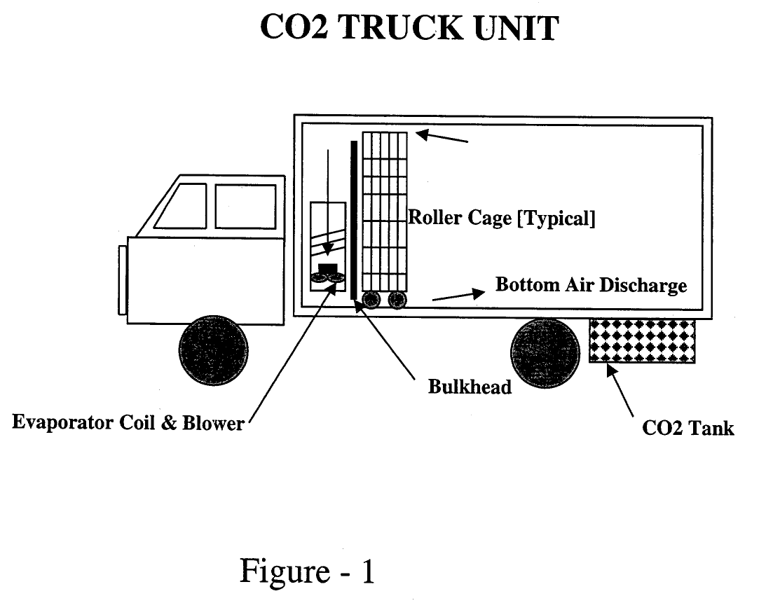

FIG. 1

The sketch shows an inner city delivery truck for which this invention is most suitable. Refrigerated goods are placed in roller cages that are designed to maximize cargo hauled by use of roller cages that extend to within 2 inches of the ceiling. The evaporator section of this invention is mounted at or near the front wall of the truck and is separated from the cargo by a vertical bulkhead. The conditioned air is delivered at the bottom of the truck to avoid top freeze of perishable cargo that is in close proximity to the ceiling.

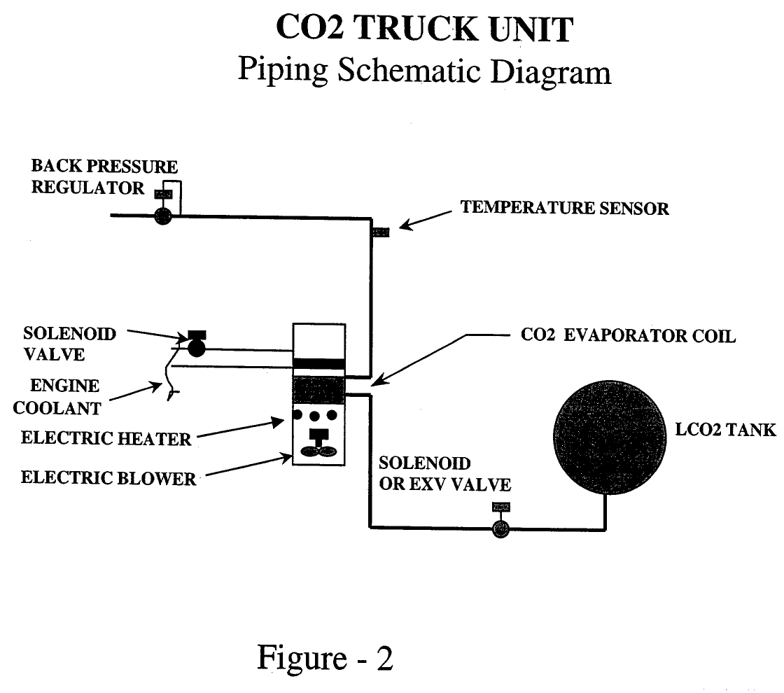

FIG. 2

This shows the piping schematic and is similar to the invention described in U.S. Application Serial No. 60/238,929 (the '929 application) incorporated herein by reference. FIG. 2 shows the engine coolant coil located ahead of the CO₂ coil in the direction of airflow. This prevents the coldest air from coming in contact with the engine coolant—in the cooling mode the air leaving the CO₂ coil can be as low as −50° F. for frozen load applications and this may cause the engine coolant to start freezing. Arrangements must be made to circulate air between the two coils in defrost mode. One means to accomplish this is to place a damper at the outlet of the evaporator section and run the fans. The damper would be closed during defrost. Another method is to place the engine coolant coil on the discharge side of the CO₂ coil and use a cut-out switch if the engine coolant temperature drops below a predetermined value. In this arrangement there is no need for the damper arrangement as the heat will rise to melt any frost on the CO₂ coil. If electric heat is used for defrost and heating freezing of the engine coolant is not a concern and the heaters can be fastened to the discharge side of the CO₂ coil.

An electric stand-by mode can be provided to power the system for cooling, heating and defrost when the vehicle is parked with the engine off. A plug-in electrical cable can provide the power needed for the controls, the fans and for heating and defrost. The figure shows the electric heaters attached on the discharge side of the CO₂ coil.

### OPERATION

Detailed description is in the '929 application except for the following:

The evaporator section is designed for vertical installation to maximize cargo space. Air is discharged at the bottom but may be a conventional top discharge if needed for specific applications. Conventional methods can be used to provide defrost and heating. If engine coolant is used for a heat source, it is preferable to thermally isolate the CO₂ coil from the engine coolant coil to avoid freezing the coolant. The evaporator blower may be located on the inlet side of the coils rather than as shown in the figures.

### UNIQUE FEATURES

1. Absence of a conventional condensing section on the exterior of the vehicle makes this an ideal refrigeration unit for small inner city delivery vehicles. Many of the truck cabs are now almost full height (same as the truck body) and there is limited space for the condensing section.

2. Cold plates can be used and still maximize cargo cube. However, this invention has 30-40% less weight than comparable “cold plate” systems.

3. Other features are described in the '929 application.

1. (New) A temperature control system for a motor vehicle having an engine and an air-conditioned space, the temperature control system comprising:
a housing having an air inlet and an air outlet, the air outlet being in fluid communication with the air-conditioned space;
an evaporator coil mounted within the housing, the evaporator coil providing a pathway for a heat-absorbing fluid between a heat-absorbing fluid tank and the atmosphere; and
a blower mounted within tie housing between the air inlet and the evaporator coil, the blower being driven by the motor vehicle engine.

2. (New) The temperature control system of claim 1, wherein the heat-absorbing fluid is a cryogen.

3. (New) The temperature control system of claim 1, further including a mechanical linkage between the engine and the blower.

4. (New) The temperature control system of claim 1, wherein the blower is driven by electric current generated by an alternator coupled to the engine.

5. (New) A temperature control system for a motor vehicle including an engine containing an engine coolant within an engine cooling flow path in the engine, and air-conditioned space, the temperature control system comprising:
a cryogenic temperature control unit including an evaporator coil; and
a heating coil adjacent to the evaporator coil, the heating coil providing a heating flow pat for the engine coolant from the engine cooling flow path and back to the engine cooling flow path.

6. (New) The temperature control system of claim 5, wherein the heating coil is integrally formed with the evaporator coil.

7. (New) A temperature control system for a motor vehicle having an engine, an alternator, and an air-conditioned space, the temperature control system comprising:
a housing having an air inlet and an air outlet, the air outlet being in fluid communication with the air-conditioned space;
an evaporator coil mounted within the housing, the evaporator coil providing a first flow path for a heat-absorbing fluid between a heat-absorbing fluid tank and the atmosphere; and
a blower mounted within the housing between the air inlet and the evaporator coil, the blower being electrically driven by current from the alternator.

8. (New) The temperature control system of claim 7, wherein the heat-absorbing fluid is a cryogen.

9. (New) The temperature control system of claim 7, wherein the heat-absorbing fluid is a refrigerant.

10. (New) A cryogenic temperature control system for a motor vehicle having an engine and an air-conditioned space, the cryogenic temperature control system comprising:
an evaporator coil through which a cryogen flows; and
a blower that blows air over the evaporator coil, the blower being driven by the engine.

11. (New) The temperature control system of claim 10, further comprising an alternator coupled to the engine, the alternator producing electric current which drives the blower.

12. (New) A temperature control system for a motor vehicle having an engine and an air conditioned space, the temperature control system comprising:
a housing having an air inlet and an air outlet, the air outlet being in fluid communication with the air-conditioned space;
an evaporator coil mounted within the housing, the evaporator coil providing a pathway for a heat-absorbing fluid;
a blower mounted within the housing between the air inlet and the evaporator coil, the blower being driven by the motor vehicle engine; and
a heating coil adjacent to the evaporator coil, the heating coil providing a heating flow path for engine coolant from the engine and back to the engine.

13. (New) The temperature control system of claim 12, wherein the heat-absorbing fluid is a cryogen.

14. (New) The temperature control system of claim 13, further including an alternator coupled to the engine, the alternator producing electric current which drives the blower.

15. (New) The temperature control system of claim 12, further comprising a compressor in fluid communication with the evaporator and wherein the heat-absorbing fluid is a refrigerant.

16. (New) The temperature control system of claim 15, wherein the beating coil is integrally formed with the evaporator coil.
